(19) United States
(12) Patent Application Publication
(10) Pub. No.: US 2018/0219881 A1
(43) Pub. Date: Aug. 2, 2018

(54) Detecting Anomalous Hypertext Transfer Protocol (HTTP) Events from Semi-Structured Data

(71) Applicant: QUALCOMM Incorporated, San Diego, CA (US)

(72) Inventors: Hilmi Gunes Kayacik, San Jose, CA (US); Dinakar Dhurjati, Santa Clara, CA (US); Mihai Christodorescu, San Jose, CA (US); Alexey Aliev, Santa Clara, CA (US)

(21) Appl. No.: 15/420,560

(22) Filed: Jan. 31, 2017

(51) Int. Cl. H04L 29/06; H04L 29/08

(52) U.S. Cl. CPC H04L 63/1416; H04L 67/02; H04L 63/02; H04L 63/1425

(57) ABSTRACT

Embodiments include computing devices, apparatus, and methods implemented by the apparatus for implementing anomalous hypertext transfer protocol (HTTP) event detection on a computing device. The computing device may receive an HTTP response, from a web application, having a first semi-structured data of a uniform resource locator (URL), store the first semi-structured data, compare a first plurality of stored semi-structured data of a plurality of URLs of a plurality of HTTP responses from the web application, identify a pattern in the first plurality of stored semi-structured data, define a first invariant for the HTTP response based on an identified pattern, and defining a first generic feature for the first invariant.

### BACKGROUND

Web application firewalls (WAFs) monitor hypertext transfer protocol (HTTP) requests to and HTTP responses from web application servers. HTTP requests and responses include universal resource locators (URLs) that can expose vulnerabilities of a web application to malicious attacks through URL manipulation, such as structured query language (SQL) injection cross site scripting attacks. Malicious attacks based on URL manipulation can be difficult to detect because URLs are often configured in a semi-structured manner. In other words, the URLs can have many variables in their structures, and it is not simple to recognize and differentiate between permissible and impermissible URLs.

### SUMMARY

Various disclosed embodiments may include apparatuses and methods for implementing anomalous hypertext transfer protocol (HTTP) event detection on a computing device. Various embodiments may include receiving an HTTP response from a web application, wherein the HTTP response has a first semi-structured data of a uniform resource locator (URL), comparing a first plurality of semi-structured data of a plurality of URLs of a plurality of HTTP responses from the web application, identifying a pattern in the first plurality of semi-structured data, defining a first invariant for the HTTP response based on an identified pattern, and defining a first generic feature for the first invariant.

Some embodiments may include identifying an argument of the first semi-structured data, determining whether the argument is the first invariant, and identifying the first generic feature of the first invariant in response to determining that the argument is the first invariant.

In some embodiments, determining whether the argument is the first invariant may include determining whether the argument is the first invariant using regular expression (regex) analysis.

Some embodiments may include identifying a script name of the first semi-structured data.

Some embodiments may include determining that the argument is a wildcard in response to determining that the argument is not the first invariant, identifying a data type for the wildcard, and identifying a data type specific feature for the wildcard.

In Some embodiments, identifying a data type for the wildcard may include identifying the data type for the wildcard using speculative casting.

Some embodiments may include receiving an HTTP request from a computing device, the HTTP request having a second semi-structured data of a URL, comparing a second plurality of semi-structured data of a plurality of URLs of a plurality of HTTP requests from a plurality of computing devices, identifying a pattern in the second plurality of semi-structured data, defining a second invariant for the HTTP request based on an identified pattern, and defining a second generic feature for the second invariant.

Some embodiments may include storing the first semi-structured data, wherein the first semi-structured data is included in the first plurality of semi-structured data, and determining whether the first plurality of semi-structured data is enough semi-structured data to build a web application anomaly detection data knowledge base including at least one of the first invariant and the first generic feature, in which defining the first invariant and defining the first generic feature may occur in response to determining that the first plurality of semi-structured data is enough semi-structured data to build the web application anomaly detection data knowledge base.

Further embodiments include a computing device having a processing device configured to perform operations of the methods summarized above. Further embodiments include a computing device having means for performing functions of the methods summarized above. Further embodiments include a non-transitory processor-readable storage medium having stored thereon processor-executable instructions configures to cause a processing device of a computing device to perform operations of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating a computing device suitable for implementing various embodiments.

FIG. 2 is a component block diagram illustrating an example multicore processor suitable for implementing various embodiments.

FIGS. 3A and 3B are block diagrams illustrating example networks implementing a web application firewall suitable for implementing various embodiments.

FIG. 4 is a block diagram illustrating an example web application firewall suitable for implementing various embodiments.

FIG. 5 is a process flow diagram illustrating a method for implementing anomalous HTTP event detection from semi-structured data according to various embodiments.

FIG. 6 is a process flow diagram illustrating a method for implementing web application anomaly detection data knowledge base building according to various embodiments.

FIG. 7 is a process flow diagram illustrating a method for implementing web application anomaly detection feature extraction according to an embodiment.

FIG. 8 is a component block diagram illustrating an example mobile computing device suitable for use with the various embodiments.

FIG. 9 is a component block diagram illustrating an example mobile computing device suitable for use with the various embodiments.

FIG. 10 is a component block diagram illustrating an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments may include methods, and systems and devices implementing such methods for discovering features in hypertext transfer protocol (HTTP) communications through a network for building anomaly detectors by analyzing HTTP exchanges (e.g., in a log file) to identify HTTP request and response arguments that appear proper. The apparatus and methods of the various embodiments may include analyzing HTTP exchanges in a computing device to identify invariants, such as script and argument names, from semi-structured text of HTTP requests and/or response uniform resource locators (URLs), and identifying data types of the arguments of the HTTP request and/or response URLs. From the identified invariants and arguments, anomaly detection features may be generated.

The terms “computing device” and “mobile computing device” are used interchangeably herein to refer to devices such as any one or all of cellular telephones, smartphones, personal or mobile multi-media players, personal data assistants (PDA's), laptop computers, tablet computers, convertible laptops/tablets (2-in-1 computers), smartbooks, ultrabooks, netbooks, palm-top computers, wireless electronic mail receivers, multimedia Internet enabled cellular telephones, mobile gaming consoles, wireless gaming controllers, and similar personal electronic devices that include a memory, a programmable processor and an interface for communicating with a network. The term “computing device” may further refer to stationary computing devices including personal computers, desktop computers, all-in-one computers, workstations, super computers, mainframe computers, embedded computers, servers, home theater computers, and game consoles.

HTTP request and/or response URLs can be semi-structured. An HTTP request and/or response URL can include a variety of script names, argument names, argument types, and/or argument values in a variety of URL configurations. HTTP request and/or response URLs for a web application (or app) can have some level of consistency dictated by domain requirements for the web application. To prevent malicious attacks based on URL manipulation, the features of the HTTP request and/or response URLs for a web application may be used to identify normal and anomalous HTTP request and/or response URLs. The features of the HTTP request and/or response URLs may include script names, argument names, argument types, and/or argument values. The features of the HTTP request and/or response URLs for a web application may be automatically identified by analyzing a log file of HTTP traffic (or monitoring a network for such traffic).

Machine learning may be employed to identify invariants for the HTTP request and/or response URLs for a web application. Machine learning may be implemented for any number of HTTP request and/or response URLs to detect patterns in the HTTP request and/or response URLs. A pattern in an HTTP request and/or response may be one or more sequences of bytes from that request and/or response, together with information about relative positions or relative time of appearance of the bytes in a network stream. The patterns in the HTTP request and/or response URLs may be identified as invariants based on the frequency of occurrence of the patterns in the overall traffic, based on the frequency of occurrence in traffic for a particular Internet Protocol (IP) address, or based on the frequency of occurrence of unique IP addresses. Patterns can be used to derive the invariants, such as invariant script names, invariant argument names, and/or invariant argument values, as well as individual invariants, combinations of invariants, and/or orders of invariants. In some embodiments, techniques to compute the invariants may include regular expression (regex) learning, which is an algorithm for deriving a regex pattern that matches all the samples from a set of patterns without matching any from other sets of patterns. As an example, a computing device may analyzes patterns occurring in a set of URLs and identify that the word “pull” occurs frequently enough (e.g., more than 65% of cases) at a repeated position in the URL. The computing device may mark the pattern as an invariant.

Using the identified invariants, generic features may be generated for detecting anomalies in HTTP request and/or response URLs. Such generic features may relate to size, frequency, and/or access patterns. Generic features of an HTTP request URL may include argument length, argument order, argument presence, file type, access frequency, periodicity, HTTP agent, HTTP command, geolocation, and/or access time. Generic features of an HTTP response URL may include content type, content size, response code, and/or requested resources.

Over time, a database of invariants may be built up. The invariants of the database may be used as features in a machine learning classifier. A classifier is an algorithm or array of decision criteria configured to process an input data (e.g., an HTTP request URL) in order to classify the data, such as whether an HTTP request URL is anomalous or not. A machine learning classifier may be generated by training the classifier using machine learning methods to recognize anomalous HTTP request URLs by having the classifier process HTTP request URLs that are known to be anomalous and non-anomalous and adjusting classifier parameters so that the correct conclusion is reached.

Elements of the HTTP request and/or response URLs that are not designated as invariants may be designated as wildcards. Wildcards may be valid elements of the HTTP request and/or response URLs that are too variable to be classified as invariants. Wildcards may include argument types and/or argument values that do not exhibit patterns and/or do not exhibit sufficient consistency to be classified as invariants.

Speculative casting of wildcards may be implemented to determine data types of the wildcards. Speculative casting may use the characters and/or combinations of characters of the arguments to determine a data type.

The wildcards may be used to generate type specific features related to the determined data types for detecting anomalies in HTTP request and/or response URLs. Type specific features of an HTTP request URL may include a range of values (for numeric data types), legal tokens (for categorical data types), alphabet (for string data types), argument presence, argument order, unprintable character ratio, non-alphanumeric character ratio, and/or structural inference (for n-gram sequences of various data types). Type specific features of an HTTP response URL may include a number of forms in a domain, inferred language, active domain nodes, text/image ratio, known external resources and scripts, and/or known form fields and actions.

The analysis to identify the invariants, generating generic features, identifying wildcards, and/or generating type specific features may incorporate knowledge of domain specific URL configurations. Regex learning may be implemented on a gathered set of HTTP request and/or response URLs, such as URLs recorded in a web log, or on a live stream of incoming HTTP request and/or outgoing HTTP response URLs.

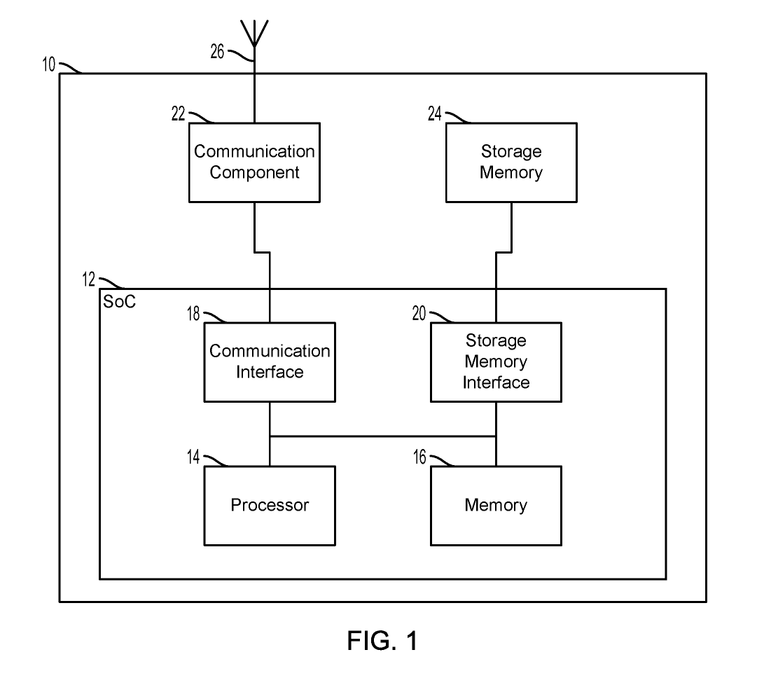

FIG. 1 illustrates a system including a computing device 10 suitable for use with the various embodiments. The computing device 10 may include a system-on-chip (SoC) 12 with a processor 14, a memory 16, a communication interface 18, and a storage memory interface 20. The computing device 10 may further include a communication component 22, such as a wired or wireless modem, a storage memory 24, and an antenna 26 for establishing a wireless communication link. The processor 14 may include any of a variety of processing devices, for example a number of processor cores.

The term “system-on-chip” (SoC) is used herein to refer to a set of interconnected electronic circuits typically, but not exclusively, including a processing device, a memory, and a communication interface. The computing device 10 may include more than one SoC 12. A processing device may include any number and variety of processors 14 and processor cores, such as a general purpose processor, a central processing unit (CPU), a digital signal processor (DSP), a graphics processing unit (GPU), an accelerated processing unit (APU), an auxiliary processor, a single-core processor, and a multicore processor. A processing device may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

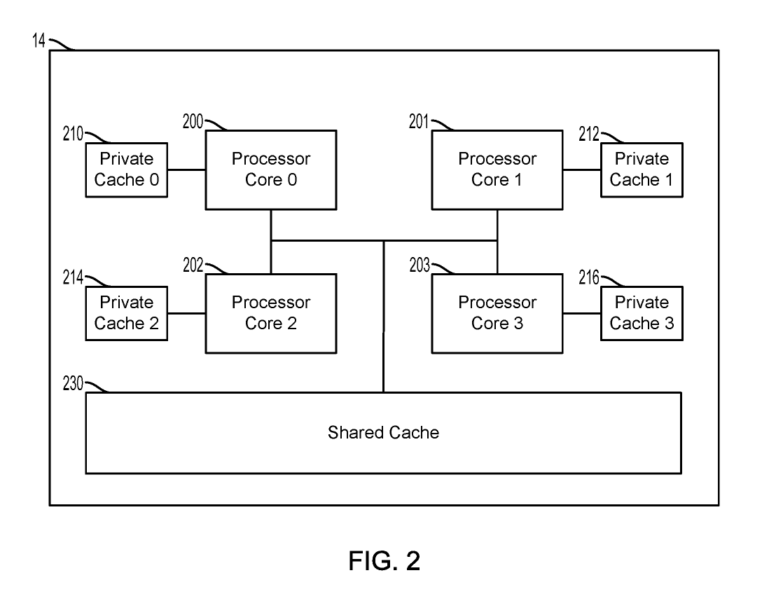

The computing device 10 may also include any number and variety of processors 14 that are not associated with an SoC 12. Individual processors 14 may be multicore processors as described below with reference to FIG. 2. The processors 14 may each be configured for specific purposes that may be the same as or different from other processors 14 of the computing device 10.

The memory 16 of the SoC 12 may be a volatile or non-volatile memory configured for storing data and processor-executable code for access by one or more processors 14. The computing device 10 and/or SoC 12 may include one or more memories 16 configured for various purposes. One or more memories 16 may include volatile memories such as random access memory (RAM) or main memory, or cache memory. These memories 16 may be configured to temporarily hold a limited amount of data and/or processor-executable code instructions for future quick access.

The storage memory interface 20 and the storage memory 24 may work in unison to allow the computing device 10 to store data and processor-executable code on a non-volatile storage medium. The storage memory 24 may be configured to store the data or processor-executable code for access by one or more of the processors 14. The storage memory 24, being non-volatile, may retain the information after the power of the computing device 10 has been shut off. When the power is turned back on and the computing device 10 reboots, the information stored on the storage memory 24 may be available to the computing device 10. The storage memory interface 20 may control access to the storage memory 24 and allow the processor 14 to read data from and write data to the storage memory 24.

Some or all of the components of the computing device 10 may be arranged differently and/or combined while still serving the functions of the various embodiments. The computing device 10 may not be limited to one of each of the components, and multiple instances of each component may be included in various configurations of the computing device 10.

FIG. 2 illustrates a multicore processor suitable for implementing an embodiment. The multicore processor 14 may include multiple processor types, including, for example, a central processing unit, a graphics processing unit, and/or a digital processing unit. The multicore processor 14 may also include a custom hardware accelerator which may include custom processing hardware and/or general purpose hardware configured to implement a specialized set of functions.

The multicore processor may have a plurality of homogeneous or heterogeneous processor cores 200, 201, 202, 203. A homogeneous multicore processor may include a plurality of homogeneous processor cores. The processor cores 200, 201, 202, 203 may be homogeneous in that, the processor cores 200, 201, 202, 203 of the multicore processor 14 may be configured for the same purpose and have the same or similar performance characteristics. For ease of reference, the terms “custom hardware accelerator,” “processor,” and “processor core” may be used interchangeably herein.

A heterogeneous multicore processor may include a plurality of heterogeneous processor cores. The processor cores 200, 201, 202, 203 may be heterogeneous in that the processor cores 200, 201, 202, 203 of the multicore processor 14 may be configured for different purposes and/or have different performance characteristics. The heterogeneity of such heterogeneous processor cores may include different instruction set architecture, pipelines, operating frequencies, etc. In various embodiments, not all off the processor cores 200, 201, 202, 203 need to be heterogeneous processor cores, as a heterogeneous multicore processor may include any combination of processor cores 200, 201, 202, 203 including at least one heterogeneous processor core.

Each of the processor cores 200, 201, 202, 203 of a multicore processor 14 may be designated a private cache 210, 212, 214, 216 that may be dedicated for read and/or write access by a designated processor core 200, 201, 202, 203. The private cache 210, 212, 214, 216 may store data and/or instructions, and make the stored data and/or instructions available to the processor cores 200, 201, 202, 203, to which the private cache 210, 212, 214, 216 is dedicated, for use in execution by the processor cores 200, 201, 202, 203. The multicore processor 14 may further include a shared cache 230 that may be configured for read and/or write access by the processor cores 200, 201, 202, 203. The shared cache 230 may function as a buffer for data and/or instructions input to and/or output from the multicore processor 14. The private cache 210, 212, 214, 216 and the shared cache 230 may include volatile memory as described herein with reference to memory 16 of FIG. 1.

For ease of explanation, the examples herein may refer to the processor cores 200, 201, 202, 203, the private caches 210, 212, 214, 216, and the shared cache 230 illustrated in FIG. 2. However, the processor cores 200, 201, 202, 203, the private caches 210, 212, 214, 216, and the shared cache 230 illustrated in FIG. 2 and described herein are merely provided as an example and in no way are meant to limit the number, combinations, and configurations of processor cores, private caches, and shared caches in various embodiments. The computing device 10, the SoC 12, or the multicore processor 14 may individually or in combination include any number, combination, and configuration of processor cores 200, 201, 202, 203, private caches 210, 212, 214, 216, and shared caches 230 illustrated and described herein.

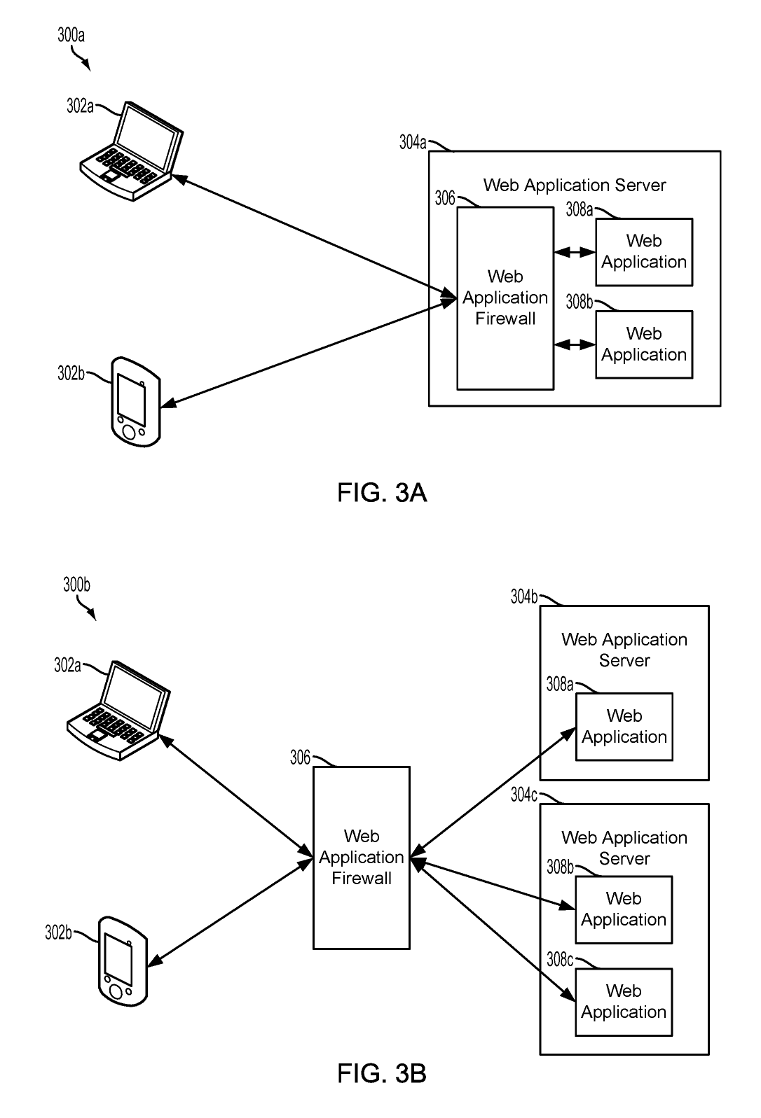

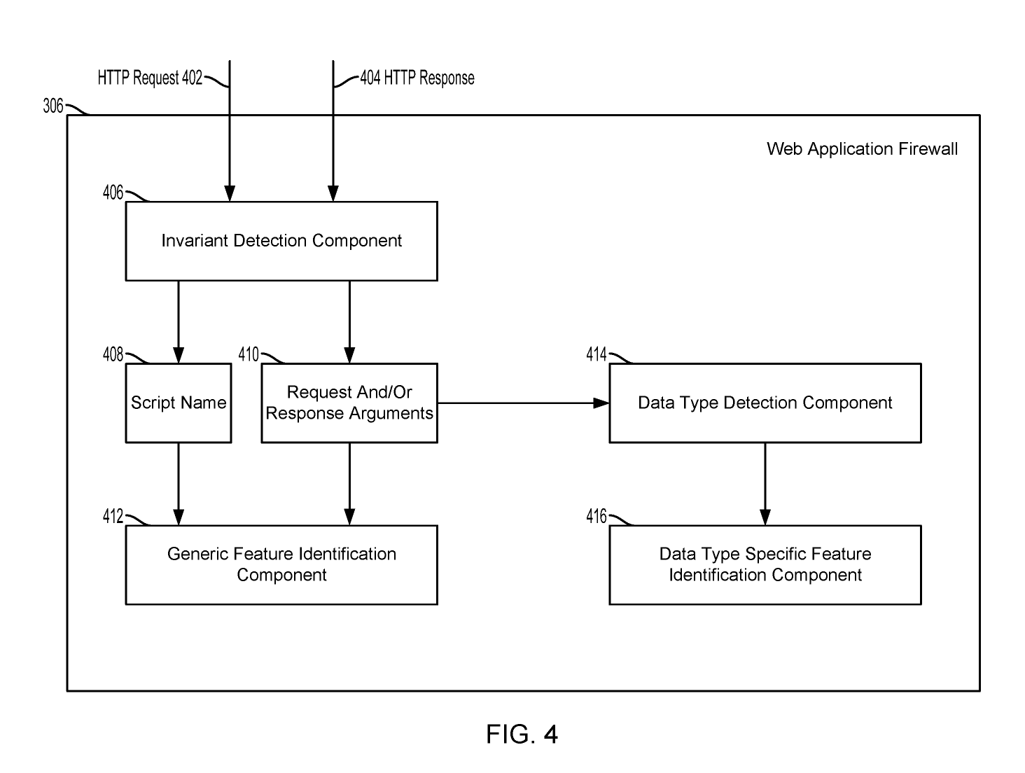

FIGS. 3A and 3B illustrate example embodiments of networks 300a, 300b implementing a web application firewall 306 suitable for implementing various embodiments. A network 300a, 300b may include a computing device 302a, 302b (e.g., computing device 10 in FIG. 1), a web application server 304a, 304b, 304c (e.g., computing device 10 in FIG. 1), a web application firewall 306 implemented as software, firmware, specialized hardware (e.g., computing device 10 in FIG. 1, processor 14 in FIGS. 1 and 2) and/or general hardware (e.g., computing device 10 in FIG. 1, processor 14 in FIGS. 1 and 2), and a web application 308a, 308b, 308c. The network 300a, 300b may include any type of data network, such as the Internet, connecting and transferring data between a computing device 302a, 302b, a web application server 304a, 304b, 304c, a web application firewall 306, and/or a web application 308a, 308b, 308c.

In various embodiments, the web application server 304a, 304b, 304c may include and/or host and execute any number of web application firewalls 306. The example in FIG. 3A illustrates the web application server 304a including and/or hosting and executing the web application firewall 306. In various embodiments, any number web application firewalls 306 may be standalone components and/or components included and/or hosted and executed by other computing devices (not shown) separate from the web application servers 304a, 304b, 304c. The example in FIG. 3B illustrates the web application firewall 306 as a component on the network 300b separate from the web application servers 304b, 304c.

Any number of web application firewalls 306 may be associated with any number of web applications 308a, 308b, 308c. In various embodiments, the web application firewall 306 may be associated with a web application 308a, 308b, 308c in a one to one relationship, the web application firewall 306 may be associated with multiple web applications 308a, 308b, 308c in a one to many relationship, multiple web application firewalls 306 may be associated with a web application 308a, 308b, 308c in a many to one relationship, and/or multiple web application firewalls 306 may be associated with multiple web applications 308a, 308b, 308c in a many to many relationship. The example in FIG. 3A illustrates the web application firewall 306 associated with multiple web applications 308a, 308b in a one to many relationship. The example in FIG. 3B illustrates the web application firewall 306 associated with multiple web applications 308a, 308b, 308c in a one to many relationship. In various embodiments, the web application firewalls 306 may be similarly associated with any number of web application servers 304a, 304b, 304c and/or web applications 308a, 308b, 308c.

Any number of computing devices 302a, 302b may send HTTP requests to a web application 308a, 308b, 308c to prompt the web application to execute and send HTTP responses in return. The computing device 302a, 302b may compose an HTTP request including semi-structured data included in a URL. The semi-structured data may specify requested action, such as a name of a script to execute, and arguments for implementing the requested action. The computing device 302a, 302b may send the HTTP request to the web application server 304a, 304b, 304c hosting the web application 308a, 308b, 308c targeted by the HTTP request. The web application server 304a, 304b, 304c may receive the HTTP request from the computing device 302a, 302b, extract the requested action and arguments from the semi-structured data included in the URL of the HTTP request, and execute the web application 308a, 308b, 308c targeted by the HTTP request in accordance with the extracted requested action and arguments. The web application 308a, 308b, 308c compose an HTTP response including semi-structured data included in a URL. The semi-structured data may specify requested action, such as a name of a script to execute, and/or arguments for implementing the requested action. The web application server 304a, 304b, 304c may send the HTTP response to the computing device 302a, 302b that sent the HTTP response.

Transmission of the HTTP request and/or HTTP response may be intercepted and/or routed through a web application firewall 306 associated with the web application 308a, 308b, 308c and/or web application server 304a, 304b, 304c. The web application firewall 306 may build a web application anomaly detection data knowledge base for the associated web application 308a, 308b, 308c, and use the anomaly detection data to extract anomaly detection features from the semi-structured data included in a URL of the HTTP request and/or HTTP response.

To build a web application anomaly detection data knowledge base for the associated web application 308a, 308b, 308c, the web application firewall 306 may gather the semi-structured data included in multiple URLs of multiple HTTP requests and/or HTTP responses. For example, URLs of multiple HTTP requests and/or HTTP responses may be stored in any number of log files, databases, or various data structures. Based upon predestinated criteria, such as frequency of inclusion and/or combination of requested actions, arguments, and/or data types of the arguments, the web application firewall 306 may identify patterns in the semi-structured data included in the URLs of the HTTP requests and/or HTTP responses. The web application firewall 306 may use the patterns to define invariants and anomaly detection features for the associated web application 308a, 308b, 308c. The invariants and anomaly detection features may provide a framework for the structure of and data that should be included in a URL of an HTTP request and/or HTTP response for the associated web application 308a, 308b, 308c. Invariants and anomaly detection features for the associated web application 308a, 308b, 308c may be defined as such upon a minimum number of occurrences in, and/or a minimum ratio or percentage of occurrences in the URLs of the HTTP requests and/or HTTP responses for the associated web application 308a, 308b, 308c. Definition of invariants and anomaly detection features may further be based on a minimum number of URLs of the HTTP requests and/or HTTP responses for the associated web application 308a, 308b, 308c.

To extract anomaly detection features from the semi-structured data included in a URL of the HTTP request and/or HTTP response, the web application firewall 306 may analyze the semi-structured data for any number of script names and/or arguments, and classify the arguments as invariants or wildcards. Identification of an invariant may be based on a comparison of the semi-structured data included in a URL of the HTTP request and/or HTTP response and the defined invariants for the associated web application 308a, 308b, 308c. The web application firewall 306 may extract anomaly detection features, such as generic features, by analysis of the script names and the arguments classified as invariants. These features may include the absence/presence of invariants, the length, relative frequency, and order of the invariants in a network stream of HTTP requests and/or HTTP responses. A wildcard classification may be used for any data of a URL not classified as an invariant. The web application firewall 306 may analyze the arguments classified as wildcards to determine the data types of each wildcard argument and to extract anomaly detection features, such as data type specific features.

The web application firewall 306 may detect an anomaly in the semi-structured data included in the URL of the HTTP request and/or HTTP response by analyzing the extracted anomaly detection features. An anomaly may be indicated by an unexpected anomaly detection feature that does not match with expected anomaly detection features of the associated web application 308a, 308b, 308c. The web application firewall 306 may take any number of actions in response to detecting an anomaly in the semi-structured data included in the URL of the HTTP request and/or HTTP response, including interrupting/blocking/terminating the HTTP request and/or HTTP response, notifying a web application administrator and/or user of the anomaly, and/or logging the occurrence of the anomaly in a file.

FIG. 4 illustrates an example embodiment of a web application firewall 306 suitable for implementing various embodiments. The example illustrated in FIG. 4 continues the examples of web application firewall 306 illustrated in FIGS. 3A and 3B. The web application firewall 306 may include and/or execute various hardware, software, and/or firmware components, including an invariant detection component 406, a generic feature identification component 412, a data type detection component 414, and a data type specific feature identification component 416. The web application firewall 306 may also include and/or be configured to access a memory (e.g., memory 16, 24 in FIG. 1, and private cache 210, 212, 214, 216 and shared cache 230 in FIG. 2) that may store various data including semi-structured data of the URLs of HTTP requests 402 and/or HTTP responses 404, data for identifying invariants, and/or data for identifying anomaly detection features.

As described herein, the web application firewall 306 may receive and/or intercept a transmission of an HTTP request 402 sent by a computing device (e.g., computing device 10, 302a, 302b in FIGS. 1 and 3) and/or an HTTP response 404 sent by a web application server (e.g., computing device 10 in FIG. 1, web application server 304a, 304b, 304c in FIG. 3) hosting and/or executing a web application (e.g., web application 308a, 308b, 308c in FIG. 3) targeted by the HTTP request 402. For the various embodiments described herein, receiving and/or intercepting a transmission and the components and means for implementing reception and/or interception of a transmission may be interchangeable. In various embodiments, receiving a transmission may include receiving a transmission addressed and routed to the web application firewall 306 and/or a computing device (e.g., computing device 10 in FIG. 1, web application server 304a, 304b, 304c in FIG. 3) executing the web application firewall 306. In various embodiments, intercepting a transmission may include monitoring, by the web application firewall 306 and/or the computing device executing the web application firewall 306, a transmission path for a transmission that is addressed to an application and/or computing device other than the the web application firewall 306 and/or the computing device executing the web application firewall 306. In various embodiments, intercepting a transmission may include monitoring for a transmission without interrupting the transmission and/or interrupting and forwarding the transmission.

The invariant detection component 406 may analyze the semi-structured data of the URL of the HTTP request 402 and/or HTTP response 404 to identify any number of script names 408 and any number of arguments 410. In various embodiments, the invariant detection component 406 may identify patterns in the semi-structured data of the URL of the HTTP request 402 and/or HTTP response 404 to build a knowledge base of invariants. The knowledge base may include any number of log files, databases, or various data structures. The invariant detection component 406 may use predestinated criteria, such as frequency of inclusion and/or combination of requested actions, arguments, and/or data types of the arguments, to identify patterns in the semi-structured data included in the URLs of the HTTP requests and/or HTTP responses. The invariant detection component 406 may define invariants upon a minimum number of occurrences, and/or a minimum ratio or percentage of occurrences of identified patterns in the URLs of the HTTP requests and/or HTTP responses for the associated web application 308a, 308b, 308c. Definitions of invariants may further be based on a minimum number of analyzed URLs of the HTTP requests and/or HTTP responses. In various embodiments, the invariant detection component 406 may implement an identification technique and/or algorithm, such as regex learning, to identify the script names 408 and arguments 410 from the semi-structured data. In various embodiments, the identification technique and/or algorithm may be trained by data including acceptable script names and arguments, and/or combinations and/or permutations of the acceptable script names and/or arguments provided by prior analysis of multiple HTTP requests 402 and/or HTTP responses 404 that may be included in the knowledge base of invariants. The identified script names 408 and arguments 410 may be classified as invariants.

The invariants may be passed to the generic feature identification component 412, which may analyze the invariants and extract generic features from the invariants. Generic features may include features related to size, frequency, and/or access patterns. Generic features for an HTTP request 402 may include a file type, an access frequency, a periodicity, an HTTP agent, an HTTP command, a geolocation, and/or an access time. Generic features for an HTTP response 404 may include a content type, a content size, a response code, and/or a requested resource.

The invariant detection component 406 may also identify wildcard data that is not identified as an invariant. The wildcards may be passed to the data type detection component 414, which may analyze the wildcards and determine a data type for each wildcard. In various embodiments, the data type detection component 414 may implement an identification technique and/or algorithm, such as speculative casting, to determine the data type for each wildcard. The data type detection component 414 may analyze the size and/or configuration of an argument to speculatively cast the argument as a specific data type. For example: a group of characters including something other than specific punctuation and numbers may be speculatively cast as a string argument; a group of numbers without punctuation may be speculatively cast as an integer argument; and a group of numbers and specific letters may be speculatively cast as a hexadecimal argument.

The data types and/or wildcards may be passed to the data type specific feature identification component 416, which may analyze the data types and/or wildcards and extract data type specific features from the data types and/or wildcards. Data type specific features may include features specific to the data types. Data type specific features for an HTTP request 402 may include an alphabet and/or language for text data types, a legal token for categorical data types, or a range and/and distribution for a numeric data type, an argument presence, a argument order, an unprintable character ratio, a non-alphanumeric character ratio, and a structural inference for an n-gram sequence data type. Data type specific features for an HTTP response 404 may include a number of forms in a document object model, an inferred language, active document object model nodes, a text/image ratio, known external resources and/or scripts, and know form fields and/or actions.

In various embodiments, the web application firewall 306 may include an anomaly detection component (not shown), which may use in-depth/context aware anomaly detection to detect a anomaly in the semi-structured data included in the URL of the HTTP request 402 and/or HTTP response 404 by analyzing the extracted anomaly detection features. An anomaly may be indicated by an unexpected anomaly detection feature that does not match with expected anomaly detection features of the web application targeted by the HTTP request 402 and/or providing the HTTP response 404. The anomaly detection component may take any number of actions in response to detecting an anomaly in the semi-structured data included in the URL of the HTTP request 402 and/or HTTP response 404, including interrupting/blocking/terminating the HTTP request 402 and/or HTTP response 404, notifying a web application administrator and/or user of the anomaly, and/or logging the occurrence of the anomaly in a file.

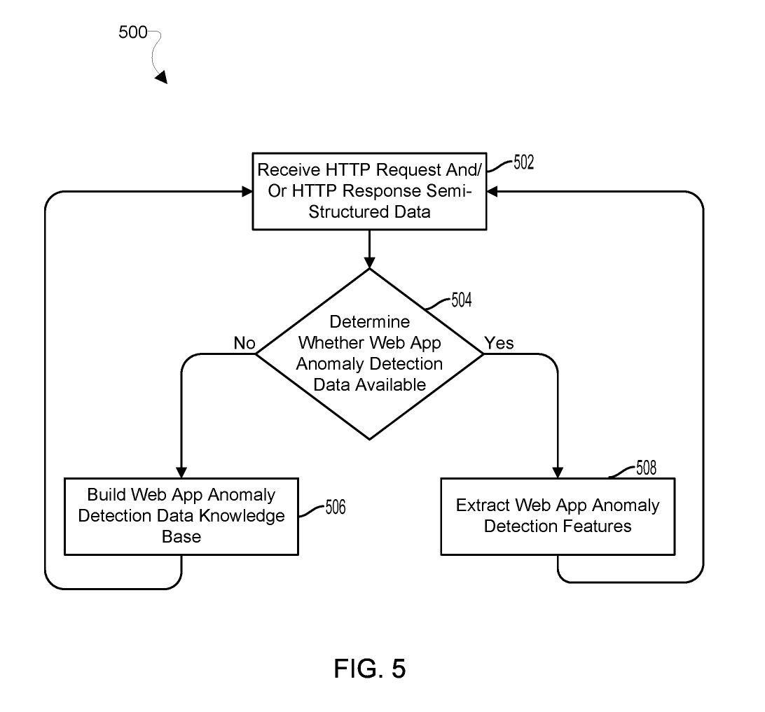

FIG. 5 illustrates a method 500 for implementing anomalous HTTP event detection from semi-structured data according to an embodiment. The method 500 may be implemented in a computing device in software executing in a processor (e.g., the processor 14 in FIGS. 1 and 2), in general purpose hardware, in dedicated hardware, or in a combination of a software-configured processor and dedicated hardware, such as a processor executing software within an web application firewall (e.g., web application firewall 306 in FIG. 3) that includes other individual components. In order to encompass the alternative configurations enabled in the various embodiments, the hardware implementing the method 500 is referred to herein as a “processing device.”

In block 502, the processing device may receive an HTTP request and/or an HTTP response having a URL with semi-structured data. In various embodiments, the HTTP request and/or the HTTP response may be routed to the processing device as part of the path for transmitting the HTTP request and/or the HTTP response between end points (e.g., computing device 302a, 302b, and web application server, 304a, 304b 304c in FIG. 3). In various embodiments, the HTTP request and/or the HTTP response may be intercepted by the processing device on a path for transmitting the HTTP request and/or the HTTP response between end points. The HTTP request may specify a target web application for executing an action for given arguments of the semi-structured data of the URL for the HTTP request, and the HTTP response may include semi-structured data of the URL for the HTTP response produced by the execution of the action by the web application.

In determination block 504, the processing device may determine whether web application anomaly detection data is available for the web application associated with the HTTP request and/or the HTTP response. A web application anomaly detection data knowledge base may be built based on analysis of multiple HTTP requests and/or HTTP responses as described further herein. The web application anomaly detection data knowledge base may be stored as a file, database, or data structure, and the processing device may determine whether web application anomaly detection data is available based on existence or population of the file, database, or data structure.

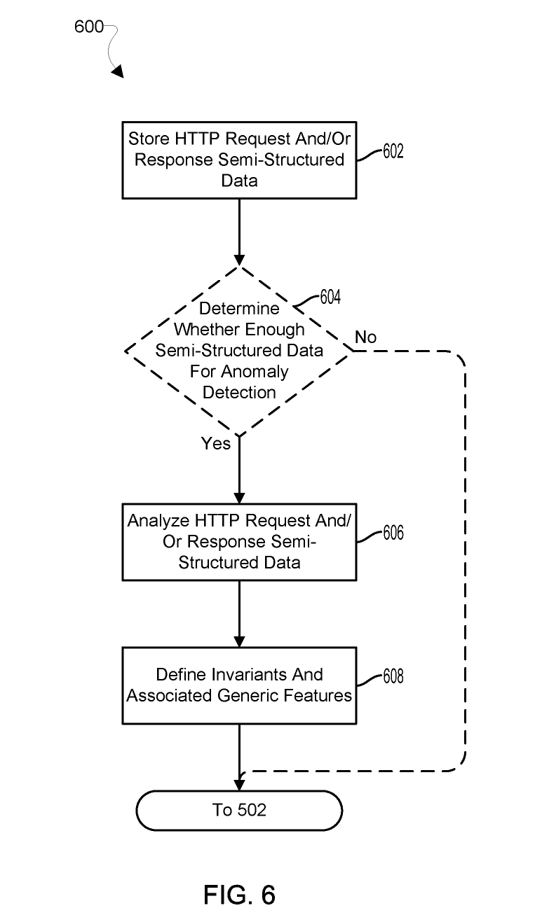

In response to determining that the web application anomaly detection data is not available for the web application associated with the HTTP request and/or the HTTP response (i.e., determination block 504=“No”), the processing device may build a web application anomaly detection data knowledge base for the web application associated with the HTTP request and/or the HTTP response in block 506, and as described further herein with reference to the method 600 in FIG. 6.

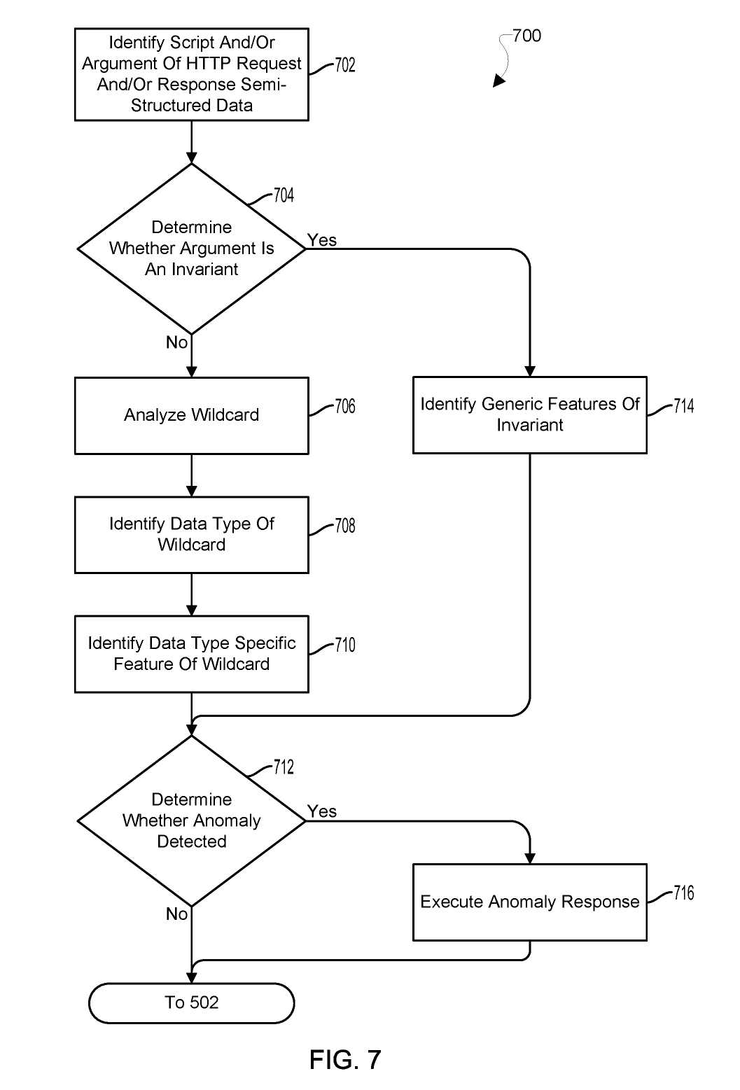

In response to determining that the web application anomaly detection data is available for the web application associated with the HTTP request and/or the HTTP response (i.e., determination block 504=“Yes”), the processing device may extract web application anomaly detection features for the web application associated with the HTTP request and/or the HTTP response in block 508, and as described further herein with reference to the method 700 in FIG. 7.

FIG. 6 illustrates a method 600 for implementing for implementing web application anomaly detection data knowledge base building according to an embodiment. The method 600 may be implemented in a computing device in software executing in a processor (e.g., the processor 14 in FIGS. 1 and 2), in general purpose hardware, in dedicated hardware, or in a combination of a software-configured processor and dedicated hardware, such as a processor executing software within an web application firewall (e.g., web application firewall 306 in FIG. 3) that includes other individual components. In order to encompass the alternative configurations enabled in the various embodiments, the hardware implementing the method 600 is referred to herein as a “processing device.” In various embodiments, the method 600 may include operations of block 506 of the method 500. In various embodiments, the method 600 may be repeatedly or periodically implemented, or may be automatically or manually prompted to be implemented, regardless of the outcome of determination block 504 in the method 500, to update the web application anomaly detection data knowledge base over time.

In block 602, the processing device may store semi-structured data of a URL of an HTTP request and/or an HTTP response. The processing device may store the semi-structured data in various forms and formats. For example, the processing device may store the semi-structured data in a file, a database, or a data structure. The semi-structured data may be stored in the same format that it is received or may be parsed out into various categories and stored according to the categories. The categories may include any number of criteria used to identify whether portions of the semi-structured data includes invariants, including frequency, location, context, periodicity, value, and type of data.

In optional determination block 604, the processing device may determine whether enough semi-structured data is gathered to be able to build a web application anomaly detection data knowledge base. In various embodiments, determination block 604 may be optional because, regardless of the amount of data collected, the processing device may continue to implement the method 600. However, doing so may result in inadequate web application anomaly detection data to identify anomalies in the semi-structured data of a URL of an HTTP request and/or an HTTP response when insufficient semi-structured data is gathered. In various embodiments, whether sufficient data semi-structured data is gathered may be based on predetermined requirements for building a web application anomaly detection data knowledge base.

In response to determining that not enough semi-structured data is gathered to be able to build a web application anomaly detection data knowledge base (i.e., determination block 604=“No”), the processing device may receive further HTTP requests and/or HTTP responses having a URL with semi-structured data in block 502 of the method 500.

In response to determining that enough semi-structured data is gathered to be able to build a web application anomaly detection data knowledge base (i.e., determination block 604=“Yes”), the processing device may analyze the semi-structured data of the URLs of the HTTP requests and/or the HTTP responses in block 606. The processing device may use various techniques and/or algorithms to analyze the semi-structured data to identify patterns in the semi-structured data that may indicate invariants in the analyzed the semi-structured data. The techniques and/or algorithms may be used to identify patterns based on various criteria, including frequency, location, context, periodicity, value, and type of data.

In block 608, the processing device may define/classify invariants and associated generic features. In various embodiments, analysis of the semi-structured data may produce analytical data related to the analyzed semi-structured data that may be used to define portions of the semi-structured data as invariants. The analytical data may be compared to predetermined requirements, such as thresholds, for being defined as invariant. In various embodiments, invariants may be defined as such upon a minimum number of occurrences, and/or a minimum ratio or percentage of occurrences of identified patterns in the URLs of the HTTP requests and/or HTTP responses. Definitions of invariants may further be based on a minimum number of analyzed URLs of the HTTP requests and/or HTTP responses. In various embodiments, the analytical data may also reveal correlations between the invariants from the semi-structured data and generic features of invariants. Generic features may include features related to size, frequency, and/or access patterns. Generic features for an HTTP request may include a file type, an access frequency, a periodicity, an HTTP agent, an HTTP command, a geolocation, and/or an access time. Generic features for an HTTP response may include a content type, a content size, a response code, and/or a requested resource. The processing device may use these correlations to define parameters for the generic features of the invariants. As discussed herein, the invariants and generic features may be stored in a file, a database, or a data structure. The processing device may receive further HTTP requests and/or HTTP responses having a URL with semi-structured data in block 502 of the method 500.

FIG. 7 illustrates a method 700 for implementing web application anomaly detection feature extraction according to an embodiment. The method 700 may be implemented in a computing device in software executing in a processor (e.g., the processor 14 in FIGS. 1 and 2), in general purpose hardware, in dedicated hardware, or in a combination of a software-configured processor and dedicated hardware, such as a processor executing software within an web application firewall (e.g., web application firewall 306 in FIG. 3) that includes other individual components. In order to encompass the alternative configurations enabled in the various embodiments, the hardware implementing the method 700 is referred to herein as a “processing device.” In various embodiments, the method 700 may include operations of block 508 of the method 500. In various embodiments, the method 700 may be executed repeatedly or in parallel with itself for multiple parts of the semi-structured data of the URL of the HTTP request and/or the HTTP response

In block 702, the processing device may identify a script name and/or an argument of the HTTP request and/or the HTTP response. The processing device may do a character analysis of the semi-structured data of the URL of the HTTP request and/or the HTTP response. The character analysis may identify specific characters in the semi-structured data as operators and/or separators, such as “=” or “/”, and as data that may be script names and/or arguments. In general, operators and/or separators may be characterized as illegal characters, and all other characters may be identified as potential script names and/or arguments. Characters may be compared to a list of known script names to identify script names in the semi-structured data, and the remaining characters may be identified as arguments.

In determination block 704, the processing device may determine whether an argument is an invariant. The identified argument may be compared to known invariants based on various criteria, including the argument's position, value, and/or context within the semi-structured data of the URL of the HTTP request and/or the HTTP response. The known invariants and criteria may be accessed from the web application anomaly detection data knowledge base. A matching comparison with invariant criteria may result in determination that the argument is an invariant. Failing to match the argument with invariant criteria may result in determination that the argument is not an invariant, and is a wildcard instead.

In response to determining that the argument is not an invariant (i.e., determination block 704=“No”) (i.e., the argument is a wildcard), the processing device may analyze the wildcard in block 706. As discussed herein, the wildcard may be analyzed to determine a data type of the wildcard. Various techniques and/or algorithms, such as speculative casting, may be used to determine the data type of the wildcard. Based on the analysis of the wildcard, in block 708, the processing may identify the data type of the wildcard.

In block 710, the processing device may identify a data type specific feature of the wildcard. Various data types may be associated with a specific feature of the data type, and the processing device may be configured to identify a value of that specific feature associated with the data type for the wildcard. The association between the data type and the data type specific feature may be predetermined.

In response to determining that the argument is an invariant (i.e., determination block 704=“Yes”), the processing device may identify a generic feature of the wildcard in block 714. As discussed herein, generic features may be defined for invariants, such as in block 608 in the method 600. The processing device may be configured to identify a value of that generic feature associated with the invariant.

Following identifying a data type specific feature of the wildcard in block 710, or identify a generic feature of the wildcard in block 714, the processing device may determine whether an anomaly is detected in determination block 712. The processing device may compare the value of the generic feature for the invariant and/or the value of the data type specific feature of the wildcard with an acceptable value or range of values for the generic feature and/or the data type specific feature. A favorable comparison of the value of the generic feature and/or the value of the data type specific feature with an acceptable value or range of values for the generic feature and/or the data type specific feature may result in determining that there is no anomaly. An unfavorable comparison of the value of the generic feature and/or the value of the data type specific feature with an acceptable value or range of values for the generic feature and/or the data type specific feature may result in determining that there is an anomaly.

In response to determining that there is an anomaly (i.e. determination block 712=“Yes”), the processing device may execute an anomaly response in block 716. In various embodiments, an anomaly response may include interrupting/blocking/terminating the HTTP request and/or HTTP response, notifying a web application administrator and/or user of the anomaly, and/or logging the occurrence of the anomaly in a file.

Following executing the anomaly response in block 716, or in response to determining that there is no anomaly (i.e., determination block 712=“No”), the processing device may receive further HTTP requests and/or HTTP responses having a URL with semi-structured data in block 502 of the method 500.

In various embodiments, multiple parts of the methods 500, 600, 700 may be implemented serially and/or in parallel, and may be implemented on different parts of the semi-structured data of any number of URLs for any number of HTTP requests and/or HTTP responses, including different parts of the semi-structured data of a URL for one HTTP request and/or HTTP response.

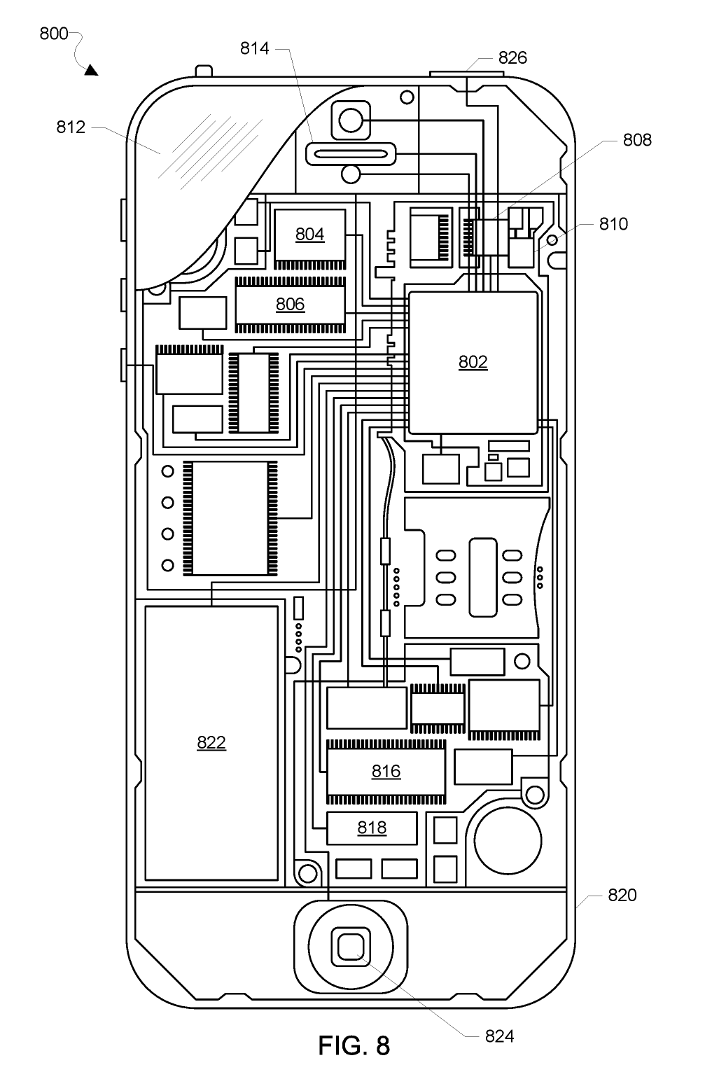

The various embodiments (including, but not limited to, embodiments described above with reference to FIGS. 1-7) may be implemented in a wide variety of computing systems including mobile computing devices (such as a smartphone or a tablet computer), an example of which suitable for use with the various embodiments is illustrated in FIG. 8. The mobile computing device 800 may include a processor 802 coupled to a touchscreen controller 804 and an internal memory 806. The processor 802 may be one or more multicore integrated circuits designated for general or specific processing tasks. The internal memory 806 may be volatile or non-volatile memory, and may also be secure and/or encrypted memory, or unsecure and/or unencrypted memory, or any combination thereof. The touchscreen controller 804 and the processor 802 may also be coupled to a touchscreen panel 812, such as a resistive-sensing touchscreen, capacitive-sensing touchscreen, infrared sensing touchscreen, etc. Additionally, the display of the computing device 800 need not have touch screen capability.

The mobile computing device 800 may have one or more radio signal transceivers 808 (e.g., Peanut, Bluetooth, ZigBee, Wi-Fi, RF radio) and antennae 810, for sending and receiving communications, coupled to each other and/or to the processor 802. The transceivers 808 and antennae 810 may be used with the above-mentioned circuitry to implement the various wireless transmission protocol stacks and interfaces. The mobile computing device 800 may include a cellular network wireless modem chip 816 that enables communication via a cellular network and is coupled to the processor.

The mobile computing device 800 may include a peripheral device connection interface 818 coupled to the processor 802. The peripheral device connection interface 818 may be singularly configured to accept one type of connection, or may be configured to accept various types of physical and communication connections, common or proprietary, such as Universal Serial Bus (USB), FireWire, Thunderbolt, or PCIe. The peripheral device connection interface 818 may also be coupled to a similarly configured peripheral device connection port (not shown).

The mobile computing device 800 may also include speakers 814 for providing audio outputs. The mobile computing device 800 may also include a housing 820, constructed of a plastic, metal, or a combination of materials, for containing all or some of the components described herein. The mobile computing device 800 may include a power source 822 coupled to the processor 802, such as a disposable or rechargeable battery. The rechargeable battery may also be coupled to the peripheral device connection port to receive a charging current from a source external to the mobile computing device 800. The mobile computing device 800 may also include a physical button 824 for receiving user inputs. The mobile computing device 800 may also include a power button 826 for turning the mobile computing device 800 on and off.

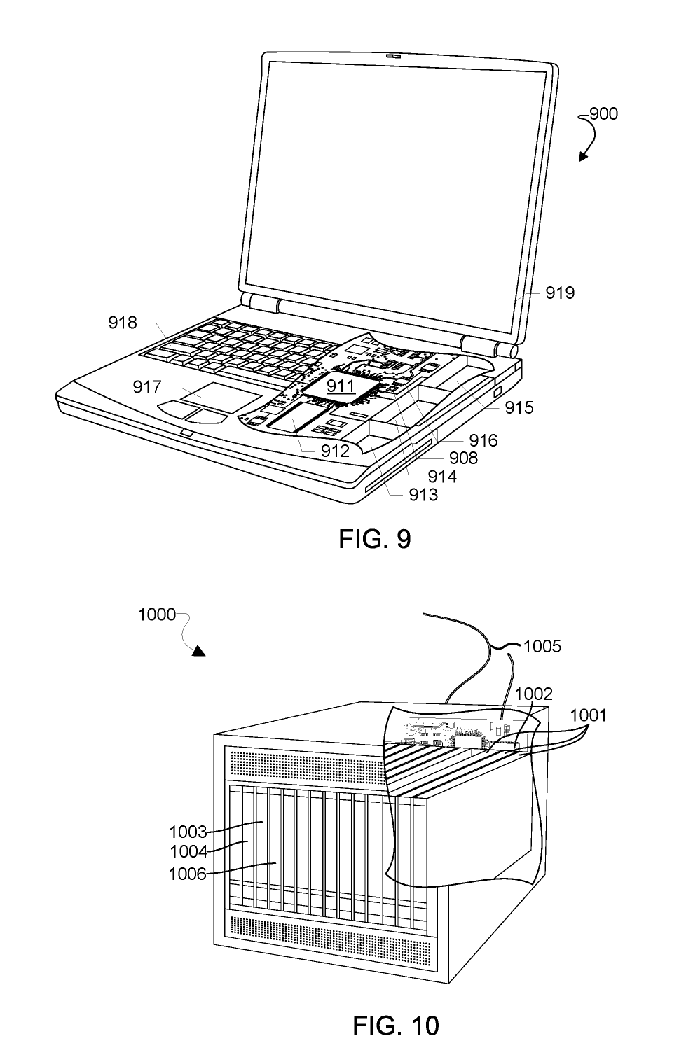

The various embodiments (including, but not limited to, embodiments described above with reference to FIGS. 1-7) may be implemented in a wide variety of computing systems include a laptop computer 900 an example of which is illustrated in FIG. 9. Many laptop computers include a touchpad touch surface 917 that serves as the computer's pointing device, and thus may receive drag, scroll, and flick gestures similar to those implemented on computing devices equipped with a touch screen display and described above. A laptop computer 900 will typically include a processor 911 coupled to volatile memory 912 and a large capacity nonvolatile memory, such as a disk drive 913 of Flash memory. Additionally, the computer 900 may have one or more antenna 908 for sending and receiving electromagnetic radiation that may be connected to a wireless data link and/or cellular telephone transceiver 916 coupled to the processor 911. The computer 900 may also include a floppy disc drive 914 and a compact disc (CD) drive 915 coupled to the processor 911. In a notebook configuration, the computer housing includes the touchpad 917, the keyboard 918, and the display 919 all coupled to the processor 911. Other configurations of the computing device may include a computer mouse or trackball coupled to the processor (e.g., via a USB input) as are well known, which may also be used in conjunction with the various embodiments. In various embodiments (including, but not limited to, embodiments described above with reference to FIGS. 1-7) the wide variety of computing systems may include a desktop computer (not shown) including any combination and configuration of the components of the laptop computer 900.

The various embodiments (including, but not limited to, embodiments described above with reference to FIGS. 1-7) may also be implemented in fixed computing systems, such as any of a variety of commercially available servers. An example server 1000 is illustrated in FIG. 10. Such a server 1000 typically includes one or more multicore processor assemblies 1001 coupled to volatile memory 1002 and a large capacity nonvolatile memory, such as a disk drive 1004. As illustrated in FIG. 10, multicore processor assemblies 1001 may be added to the server 1000 by inserting them into the racks of the assembly. The server 1000 may also include a floppy disc drive, compact disc (CD) or digital versatile disc (DVD) disc drive 1006 coupled to the processor 1001. The server 1000 may also include network access ports 1003 coupled to the multicore processor assemblies 1001 for establishing network interface connections with a network 1005, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

Computer program code or “program code” for execution on a programmable processor for carrying out operations of the various embodiments may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein, but is to be accorded the widest scope consistent with the following claims and the principles and novel features disclosed herein.

What is claimed is:

1. A method of implementing anomalous hypertext transfer protocol (HTTP) event detection on a computing device, comprising:
receiving an HTTP response from a web application, wherein the HTTP response has a first semi-structured data of a uniform resource locator (URL);
comparing a first plurality of semi-structured data of a plurality of URLs of a plurality of HTTP responses from the web application;
identifying a pattern in the first plurality of semi-structured data;
defining a first invariant for the HTTP response based on an identified pattern; and
defining a first generic feature for the first invariant.

2. The method of claim 1, further comprising:
identifying an argument of the first semi-structured data;
determining whether the argument is the first invariant; and
identifying the first generic feature of the first invariant in response to determining that the argument is the first invariant.

3. The method of claim 2, wherein determining whether the argument is the first invariant comprises determining whether the argument is the first invariant using regular expression (regex) analysis.

4. The method of claim 2, further comprising identifying a script name of the first semi-structured data.

5. The method of claim 2, further comprising:
determining that the argument is a wildcard in response to determining that the argument is not the first invariant;
identifying a data type for the wildcard; and
identifying a data type specific feature for the wildcard.

6. The method of claim 5, wherein identifying a data type for the wildcard comprises identifying the data type for the wildcard using speculative casting.

7. The method of claim 1, further comprising:
receiving an HTTP request from a computing device, the HTTP request having a second semi-structured data of a URL;
comparing a second plurality of semi-structured data of a plurality of URLs of a plurality of HTTP requests from a plurality of computing devices;
identifying a pattern in the second plurality of semi-structured data;
defining a second invariant for the HTTP request based on an identified pattern; and
defining a second generic feature for the second invariant.

8. The method of claim 1, further comprising:
storing the first semi-structured data, wherein the first semi-structured data is included in the first plurality of semi-structured data; and
determining whether the first plurality of semi-structured data is enough semi-structured data to build a web application anomaly detection data knowledge base including at least one of the first invariant and the first generic feature, wherein defining the first invariant and defining the first generic feature occur in response to determining that the first plurality of semi-structured data is enough semi-structured data to build the web application anomaly detection data knowledge base.

9. A computing device, comprising:
a processing device configured to perform operations comprising:
receiving a hypertext transfer protocol (HTTP) response from a web application, wherein the HTTP response has a first semi-structured data of a uniform resource locator (URL);
comparing a first plurality of semi-structured data of a plurality of URLs of a plurality of HTTP responses from the web application;
identifying a pattern in the first plurality of semi-structured data;
defining a first invariant for the HTTP response based on an identified pattern; and
defining a first generic feature for the first invariant.

10. The computing device of claim 9, wherein the processing device is configured with processor-executable instructions to perform operations further comprising:
identifying an argument of the first semi-structured data;
determining whether the argument is the first invariant; and
identifying the first generic feature of the first invariant in response to determining that the argument is the first invariant.

11. The computing device of claim 10, wherein the processing device is configured with processor-executable instructions to perform operations such that determining whether the argument is the first invariant comprises determining whether the argument is the first invariant using regular expression (regex) analysis.

12. The computing device of claim 10, wherein the processing device is configured with processor-executable instructions to perform operations further comprising identifying a script name of the first semi-structured data.

13. The computing device of claim 10, wherein the processing device is configured with processor-executable instructions to perform operations further comprising:
determining that the argument is a wildcard in response to determining that the argument is not the first invariant;
identifying a data type for the wildcard; and
identifying a data type specific feature for the wildcard.

14. The computing device of claim 13, wherein the processing device is configured with processor-executable instructions to perform operations such that identifying a data type for the wildcard comprises identifying the data type for the wildcard using speculative casting.

15. The computing device of claim 9, wherein the processing device is configured with processor-executable instructions to perform operations further comprising:
receiving an HTTP request from a computing device, the HTTP request having a second semi-structured data of a URL;
comparing a second plurality of semi-structured data of a plurality of URLs of a plurality of HTTP requests from a plurality of computing devices;
identifying a pattern in the second plurality of semi-structured data;
defining a second invariant for the HTTP request based on an identified pattern; and
defining a second generic feature for the second invariant.

16. The computing device of claim 9, wherein the processing device is configured with processor-executable instructions to perform operations further comprising:
storing the first semi-structured data, wherein the first semi-structured data is included in the first plurality of semi-structured data; and
determining whether the first plurality of semi-structured data is enough semi-structured data to build a web application anomaly detection data knowledge base including at least one of the first invariant and the first generic feature, wherein defining the first invariant and defining the first generic feature occur in response to determining that the first plurality of semi-structured data is enough semi-structured data to build the web application anomaly detection data knowledge base.

17. A computing device, comprising:
means for receiving a hypertext transfer protocol (HTTP) response from a web application, wherein the HTTP response has a first semi-structured data of a uniform resource locator (URL);
means for comparing a first plurality of semi-structured data of a plurality of URLs of a plurality of HTTP responses from the web application;
means for identifying a pattern in the first plurality of semi-structured data;
means for defining a first invariant for the HTTP response based on an identified pattern; and
means for defining a first generic feature for the first invariant.

18. The computing device of claim 17, further comprising:
means for identifying an argument of the first semi-structured data;
means for determining whether the argument is the first invariant; and
means for identifying the first generic feature of the first invariant in response to determining that the argument is the first invariant.

19. The computing device of claim 18, wherein means for determining whether the argument is the first invariant comprises means for determining whether the argument is the first invariant using regular expression (regex) analysis.

20. The computing device of claim 18, further comprising means for identifying a script name of the first semi-structured data.

21. The computing device of claim 18, further comprising:
means for determining that the argument is a wildcard in response to determining that the argument is not the first invariant;
means for identifying a data type for the wildcard; and
means for identifying a data type specific feature for the wildcard.

22. The computing device of claim 17, further comprising:
means for receiving an HTTP request from a computing device, the HTTP request having a second semi-structured data of a URL;
means for comparing a second plurality of semi-structured data of a plurality of URLs of a plurality of HTTP requests from a plurality of computing devices;
means for identifying a pattern in the second plurality of semi-structured data;
means for defining a second invariant for the HTTP request based on an identified pattern; and
means for defining a second generic feature for the second invariant.

23. The computing device of claim 17, further comprising:
means for storing the first semi-structured data, wherein the first semi-structured data is included in the first plurality of semi-structured data; and
means for determining whether the first plurality of semi-structured data is enough semi-structured data to build a web application anomaly detection data knowledge base including at least one of the first invariant and the first generic feature, wherein means for defining the first invariant and means for defining the first generic feature are implemented in response to determining that the first plurality of semi-structured data is enough semi-structured data to build the web application anomaly detection data knowledge base.

24. A non-transitory processor-readable storage medium having stored thereon processor-executable instructions configured to cause a processor of a computing device to perform operations comprising:
receiving a hypertext transfer protocol (HTTP) response from a web application, wherein the HTTP response has a first semi-structured data of a uniform resource locator (URL);
comparing a first plurality of semi-structured data of a plurality of URLs of a plurality of HTTP responses from the web application;
identifying a pattern in the first plurality of semi-structured data;
defining a first invariant for the HTTP response based on an identified pattern; and
defining a first generic feature for the first invariant.

25. The non-transitory processor-readable storage medium of claim 24, wherein the stored processor-executable instructions are configured to cause the processor of the computing device to perform operations further comprising:
identifying an argument of the first semi-structured data;
determining whether the argument is the first invariant; and
identifying the first generic feature of the first invariant in response to determining that the argument is the first invariant.

26. The non-transitory processor-readable storage medium of claim 25, wherein the stored processor-executable instructions are configured to cause the processor of the computing device to perform operations such that determining whether the argument is the first invariant comprises determining whether the argument is the first invariant using regular expression (regex) analysis.

27. The non-transitory processor-readable storage medium of claim 25, wherein the stored processor-executable instructions are configured to cause the processor of the computing device to perform operations further comprising identifying a script name of the first semi-structured data.

28. The non-transitory processor-readable storage medium of claim 25, wherein the stored processor-executable instructions are configured to cause the processor of the computing device to perform operations further comprising:
determining that the argument is a wildcard in response to determining that the argument is not the first invariant;
identifying a data type for the wildcard; and
identifying a data type specific feature for the wildcard.

29. The non-transitory processor-readable storage medium of claim 24, wherein the stored processor-executable instructions are configured to cause the processor of the computing device to perform operations further comprising:
receiving an HTTP request from a computing device, the HTTP request having a second semi-structured data of a uniform resource locator (URL);
comparing a second plurality of semi-structured data of a plurality of URLs of a plurality of HTTP requests from a plurality of computing devices;
identifying a pattern in the second plurality of semi-structured data;
defining a second invariant for the HTTP request based on an identified pattern; and
defining a second generic feature for the second invariant.

30. The non-transitory processor-readable storage medium of claim 24, wherein the stored processor-executable instructions are configured to cause the processor of the computing device to perform operations further comprising:
storing the first semi-structured data, wherein the first semi-structured data is included in the first plurality of semi-structured data; and
determining whether the first plurality of semi-structured data is enough semi-structured data to build a web application anomaly detection data knowledge base including at least one of the first invariant and the first generic feature, wherein defining the first invariant and defining the first generic feature occur in response to determining that the first plurality of semi-structured data is enough semi-structured data to build the web application anomaly detection data knowledge base.
